(19) United States
(12) Patent Application Publication
(10) Pub. No.: US 2008/0196676 A1
(43) Pub. Date: Aug. 21, 2008

(54) Self supporting pet toy

(76) Inventors: Jee Kim, San Francisco, CA (US); Gary Lau, Siu Lek Yuen Shatin (HK); Erwin del Pinal, Albany, CA (US)

Correspondence Address: Dergosits & Noah LLP, Suite 1450, Four Embarcadero Center, San Francisco, CA, 94111, US

(21) Appl. No.: 11/709,398

(22) Filed: Feb. 21, 2007

(51) Int. Cl. A01K 29/00

(52) U.S. Cl. 119/707

(57) ABSTRACT

A pet activity toy which includes an attachment, extender and base. The attachment is in the form of, for example, a pet toy for attracting and engaging a pet. The extender is in the form of a flexible wand releaseably appended to the attachment by use of a first snap fit connector. The base is employed as a stabilizer element for maintaining the proper orientation of the wand, the base being releaseably connected to the wand by use of a second snap fit connector.

### TECHNICAL FIELD

The present invention involves a pet activity toy that can be used by a wide variety of domestic pets, and, preferably, domestic cats. The pet activity toy includes a base, an attachment, connectable to the base directly or through the use of an extender. Through the use of the present invention, the attachment or toy can be readily removed and replaced when worn or to promote further interest on behalf of the pet noting that the various elements engage one another through the use of snap fit connectors making the interchangeability of parts convenient while minimizing physical risks inherent in the use of any toy designed for use by pets.

### BACKGROUND OF THE INVENTION

Pets, particularly cats, have a natural curiosity that is constantly being challenged and satisfied. Cats enjoy swatting at moving objects such as bundled feathers, plush stuffed mice and balls; activity oftentimes being enhanced by catnip.

In providing a system for engaging a pet's natural curiosity, certain challenges inherently present themselves. For example, many of the toys, such as feathered bundles and stuffed animals are easily degraded and virtually destroyed as the cat begins to take active interest in the toy by clawing, biting and pulling upon it for extended periods of time. Thus, in order to extend the life of a pet activity toy, it would be advantageous for a pet owner to be able to remove the toy at any time from the system and replace it with a new one thus extending the life of the overall system, generally. In addition, toys, such as those disclosed herein, even when not degraded or destroyed, eventually prove to be of lessening interest to a pet as familiarity with the toy results in boredom. It is thus an object of the invention to be able to retain a good portion of the pet activity toy while being able to replace a toy attachment to stimulate a pet.

Finally, when pet toys are made available as multi-part systems, some thought should be given to how the various parts of the system disengage and whether certain parts of the system should disengage over others. The system should also contemplate a universal interface between parts to enable ready interchange of such parts without having to replace the system, at large.

These and other further objects of the present invention will be become more readily apparent when considering the following disclosure and appended claims.

### SUMMARY OF THE INVENTION

A pet activity toy comprising an attachment, extender and base, said attachment comprising a pet toy for attracting and engaging a pet, said extender comprising a flexible wand releaseably appended to said attachment by use of a first snap fit connector and said base comprising a stabilizer element for maintaining the proper orientation of said wand and attachment, said base being releaseably connected to said wand by use of a second snap fit connector.

### BRIEF DESCRIPTION OF THE FIGURES

FIG. 1 is a perspective view of a pet activity toy of the present invention.

FIG. 2 is a partially contracted view of the present invention shown in an expanded or disassembled state.

FIGS. 3 and 4 are perspective views of typical snap fit connector parts for use in practicing the present invention.

FIG. 5 is a perspective view of a typical wand and snap fit connectors used in practicing the present invention.

### DETAILED DESCRIPTION OF THE INVENTION

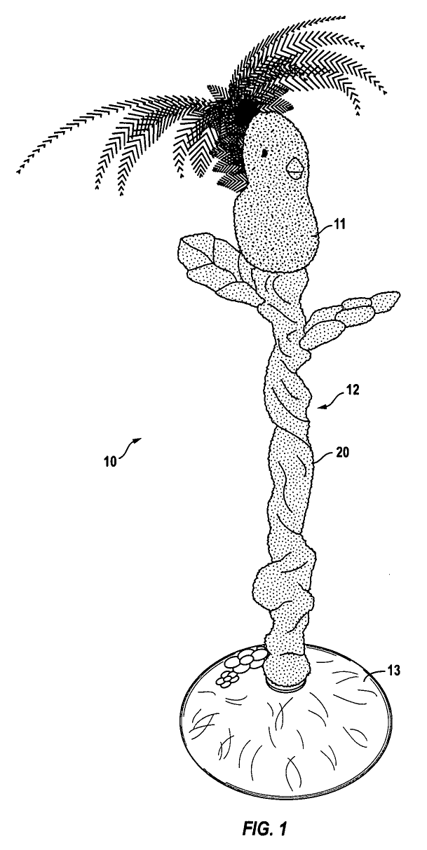

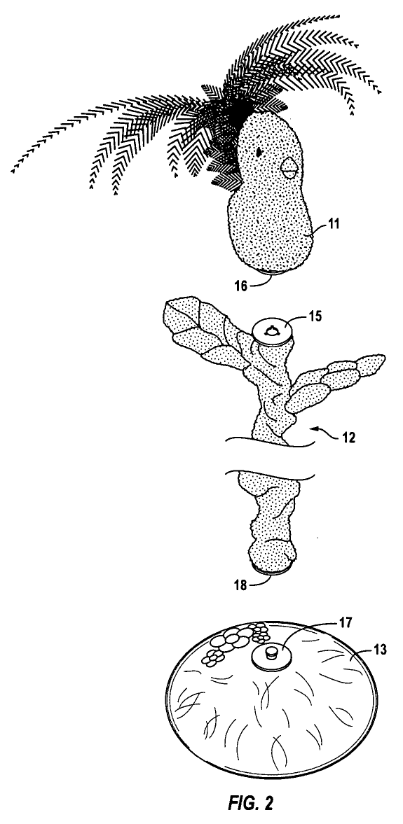

Turning first to FIG. 1, pet activity toy 10 is depicted having attachment 11, extender 12 and base 13. It is intended that base 13 have a flat bottom capable of residing on a horizontal surface such as a floor, desk, or other domestic or pet furniture and related items. Base 13 can be weighted to provide stability or other fixation elements can be employed, such as suction cups (not shown) to the same end. Ideally, attachment 11 is in the form of a pet toy, in this case, a stuffed animal, although other attachments can be employed in conjunction with the depicted stuffed animal or as a substitute for it. For example, attachment 11 can include feathered bundles while attachment can contain attractants such as catnip, bells, electric sound generators, crackle fabrics and lights to enhance a pet's interest.

It is contemplated that extender 12 be in the shape of a wand which has the capability of allowing an attachment to move, bounce, be displaced from its normal vertical orientation and swing back into position to again enhance a pet's interest. For example, it is contemplated that stuffed bird toy 11, filled with catnip and a sound generator would represent the ideal target for a cat to swat. Upon doing so, the stuffed toy would be displaced from its at rest vertical orientation as shown in the figures but would recover into this orientation within a short number of periodic swings. This can be accomplished by providing wand 12 in the form of a helical spring 19 although other resilient wands, sticks or cylinders can be employed for this purpose. For safety and aesthetic concerns, helical spring 19 can be encased in fabric sheath 20.

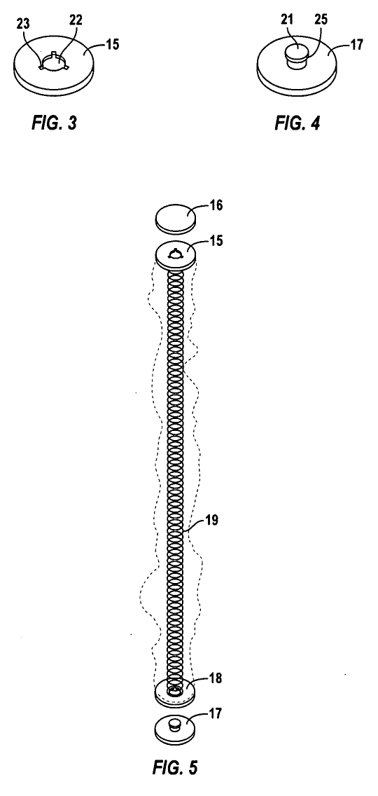

The various component parts of the present invention are intended to releaseably connect to one another using first and second snap fit connectors shown as connector pairs 15-16 and 17-18. Each of the snap fit connectors are intended to have male and female portions which connect to one another perhaps best visualized in reference to FIGS. 3 and 4. In this regard, female connector portion 15 is provided with opening 22 for receipt of a male portion shown as element 21 of snap fit connector part 17. Expanded region 25 pushes within opening 22 facilitated by cut out tabs 23 located 120 degrees apart on circular cut out region 22. By changing the relative dimensions between the male and female parts or by changing the actual materials in which the snap fit connectors are configured will dictate the relative strength of the connections and the tenacity necessary to disengage the parts either inadvertently or at will.

As previously noted, as a preferred embodiment, its contemplated that the snap fit connector pairs 15-16 and 17-18 vary in the force necessary to release them for a variety of reasons. For example, it may be preferable to provide snap fit connector pair 17-18 as a tighter more resistant fit than pair 15-16 to readily enable a user to replace and change attachment 11. Alternatively, snap fit connector pair 15-16 may be more resistant to disengagement in order to resist removal of attachment 11 from extender 12 to prevent a small toy from being swallowed or otherwise ingested causing potential harm to a pet.

It is also contemplated that, at times, snap fit connector pair 17-18 may be quite easy to disengage if there is a sense that aggressive use of pet activity toy 10 may result in extender 12 wrapping about the neck of a pet resulting in asphyxiation or other injury, particularly when human supervision is not readily at hand. It might also behoove pet activity toy 10 to provide snap fit connector pair 17-18 with a relatively easy disengagement force in the event that one wishes to prevent dislodgement of base 13 from a surface rather seeing that extender 12 disengage from the base before the base is toppled or otherwise dislodged from the support. This might be of particular interest if base 13 resides upon a desk or other article of furniture somewhat at an elevated position above a floor. If a base was to be somewhat heavy, one might wish to disengage extender 12 and attachment 11 prior to the base flipping off the desk and crashing onto the floor causing potential damage.

Finally, use of the present invention can also entail eliminating extender 12 in its entirety while placing attachment 11 directly upon base 13. Although, in doing so, the benefits of having a flexible wand would be eliminated, having this flexibility could add to the prolonged interest that a pet would show to the pet activity toy by varying its presentation.

1. A pet activity toy comprising an attachment, extender and base, said attachment comprising a pet toy for attracting and engaging a pet, said extender comprising a flexible wand releasably appended to said attachment by use of a first snap fit connector and said base comprising a stabilizer element for maintaining the proper orientation of said wand and attachment, said base being releaseably connected to said wand by use of a second snap fit connector.

2. The pet activity toy of claim 1 wherein said attachment further comprises an attractant for a pet comprising a member selected from the group consisting of feathered bundles, catnip, bells, electronic sound generators, crackle fabrics and lights.

3. The pet activity toy of claim 1 wherein said attachment comprises a stuffed animal.

4. The pet activity toy of claim 3 wherein said stuffed animal further comprises an electronic sound generator.

5. The pet activity toy of claim 1 wherein said extender comprises a helical spring.

6. The pet activity toy of claim 5 wherein said helical spring is encased in a fabric sheath.

7. The pet activity toy of claim 1 wherein said base comprises a weighted body having a substantially flat bottom for engagement with a horizontal surface.

8. The pet activity toy of claim 7 wherein said base further comprises a releaseable fixation element.

9. The pet activity toy of claim 1 wherein said first and second snap connectors require different forces to disengage those portions of the pet activity toy that they connect from one another.
